(19) United States
(12) Patent Application Publication
(10) Pub. No.: US 2020/0152082 A1
(43) Pub. Date: May 14, 2020

(54) ELECTRONIC TEACHING GAMES

(71) Applicant: Jo-Anne Dressendofer, Point Pleasant, NJ (US)

(72) Inventor: Jo-Anne Dressendofer, Point Pleasant, NJ (US)

(21) Appl. No.: 16/684,675

(22) Filed: Nov. 15, 2019

Related U.S. Application Data
(63) Continuation-in-part of application No. 14/810,459, filed on Jul. 27, 2015, now abandoned.
(60) Provisional application No. 62/151,697, filed on Apr. 23, 2015.
(60) Provisional application No. 62/029,536, filed on Jul. 27, 2014.

(51) Int. Cl. G09B 19/22; G09B 5/02; A63F 13/822

(52) U.S. Cl. CPC G09B 19/22; A63F 2300/807; A63F 13/822; G09B 5/02

(57) ABSTRACT

An electronic game displays a randomly selected virtual card on each of a series of turns. The set of virtual cards correspond to both player's and opponent's game pieces. A GUI displays a board and available moves corresponding to the displayed virtual card. Available moves for a player's turn may involve moving the player's own piece, moving an opponent's piece, or both. In embodiments, game data is assigned to first and second players, and the player's game data may be switched during game play. An embodiment of the game is used for teaching chess strategy.

### CROSS REFERENCE TO RELATED APPLICATIONS

This application is a continuation-in-part of U.S. application Ser. No. 14/810,459, filed Jul. 27, 2015, which claims benefit of U.S. Provisional Application No. 62/029,536, filed on Jul. 27, 2014, and 62/151,697, filed on Apr. 23, 2015, which are all hereby incorporated in their entirety.

### FIELD OF INVENTION

The invention is related to games, and more particularly to electronic games for teaching game strategy.

### BACKGROUND OF THE INVENTION

The invention relates generally to games, such as strategy games like chess, backgammon, checkers, Parcheesi, Crash Landing, etc. and word games like Scrabble®. There are often times when the skill levels between the players vary significantly, which may take away from the experience. It may be boring for the more-skilled player, and discouraging for the less-skilled player. Thus, players of different skill levels may avoid playing each other.

Additionally, certain games may be difficult to teach because of the complexity of the game and the strategy involved.

Moreover, certain games that have been around for many years, such as chess, checkers, etc. may be deemed boring and dated.

Accordingly, it is desirable to provide an improved game, and a system and method for playing and teaching a game that overcomes drawbacks and inadequacies of known methods and systems. It is also desirable to provide a system for modifying a game without changing the game in itself, so that players have the option of playing the original game or the modified version of the game.

### SUMMARY OF THE INVENTIONS

Generally speaking, in accordance with an embodiment of the invention, an electronic teaching a game includes an article comprising a tangible medium that is not a transitory propagating signal encoding computer-readable instructions that, when applied to a computer system, instruct the computer system to perform operations for playing a game comprising a series of turns by a player and an opponent, the operations comprising: providing a plurality of player's game pieces, a plurality of opponent's game pieces, and a board; providing a plurality of virtual cards, wherein the plurality of virtual cards comprise a first set of piece cards each corresponding to one of the plurality of player's game pieces, and a second set of piece cards each corresponding to one of the plurality of opponent's game pieces; displaying, during the player's turn, one of the plurality of virtual cards randomly selected from a subset of the plurality of virtual cards, the subset including at least one card belonging to the first set of piece cards and at least one card belonging to the second set of piece cards; and displaying on the board available moves corresponding to the displayed virtual card.

In an embodiment, the player's game pieces and the opponent's game pieces are chess pieces.

In an embodiment, the operations further include assigning first player game data to the player and second player game data to the opponent, wherein the first player game data and second player game data include at least one of: piece data associated with the player, board orientation associated with the player, special pieces or cards held by the player, player's order of play, a score, or a handicap. In another embodiment, the plurality of virtual cards further comprises a switch card, and when the switch card is the displayed virtual card, assigning first player game data to the opponent and assigning second player game data to the player.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawing, in which:

FIG. 1A is an illustration of a piece card instructing the player to move the black bishop in accordance with an embodiment of the invention;

FIG. 1B is an illustration of a piece card instructing the player to move the black king in accordance with an embodiment of the invention;

FIG. 1C is an illustration of a piece card instructing the player to move the black knight in accordance with an embodiment of the invention;

FIG. 1D is an illustration of a piece card instructing the player to move the black pawn in accordance with an embodiment of the invention;

FIG. 1E is an illustration of a piece card instructing the player to move the black queen in accordance with an embodiment of the invention;

FIG. 1F is an illustration of a piece card instructing the player to move the black rook in accordance with an embodiment of the invention;

FIG. 1G is an illustration of a piece card instructing the player to move the white bishop in accordance with an embodiment of the invention;

FIG. 1H is an illustration of a piece card instructing the player to move the white king in accordance with an embodiment of the invention;

FIG. 1I is an illustration of a piece card instructing the player to move the white knight in accordance with an embodiment of the invention;

FIG. 1J is an illustration of a piece card instructing the player to move the white pawn in accordance with an embodiment of the invention;

FIG. 1K is an illustration of a piece card instructing the player to move the white queen in accordance with an embodiment of the invention;

FIG. 1L is an illustration of a piece card instructing the player to move the white rook in accordance with an embodiment of the invention;

FIG. 2A is an illustration of a special move card in accordance with an embodiment of the invention;

FIG. 2B is an illustration of a special move card instructing the player to lose a move in accordance with an embodiment of the invention;

FIG. 2C is an illustration of a special move card instructing the player to remove any pawn in accordance with an embodiment of the invention;

FIG. 2D is an illustration of a special move card instructing the player to return any piece to the board in accordance with an embodiment of the invention;

FIG. 2E is an illustration of a special move card instructing players to void a move that would capture the king in accordance with an embodiment of the invention;

FIG. 2F is an illustration of a special move card instructing players to switch sides in accordance with an embodiment of the invention;

FIG. 2G is an illustration of a special move card allowing the player to move any piece on the board in accordance with an embodiment of the invention;

FIG. 3A is an illustration of possible moves on a chessboard when a black pawn card is drawn in accordance with an embodiment of the invention;

FIG. 3B is an illustration of possible moves on a chessboard when a white pawn card is drawn in accordance with an embodiment of the invention;

FIG. 3C is an illustration of possible moves on a chessboard when a black rook card is drawn in accordance with an embodiment of the invention;

FIG. 3D is an illustration of possible moves on a chessboard when a white rook card is drawn in accordance with an embodiment of the invention;

FIG. 3E is an illustration of possible moves on a chessboard when a black bishop card is drawn in accordance with an embodiment of the invention;

FIG. 3F is an illustration of possible moves on a chessboard when a white bishop card is drawn in accordance with an embodiment of the invention;

FIG. 3G is an illustration of possible moves on a chessboard when a black knight card is drawn in accordance with an embodiment of the invention;

FIG. 3H is an illustration of possible moves on a chessboard when a white knight card is drawn in accordance with an embodiment of the invention;

FIG. 3I is an illustration of possible moves on a chessboard when a black queen card is drawn in accordance with an embodiment of the invention;

FIG. 3J is an illustration of possible moves on a chessboard when a white queen card is drawn in accordance with an embodiment of the invention;

FIG. 3K is an illustration of possible moves on a chessboard when a black king card is drawn in accordance with an embodiment of the invention;

FIG. 3L is an illustration of possible moves on a chessboard when a white king card is drawn in accordance with an embodiment of the invention;

FIG. 4A is an illustration of exemplary instructions in accordance with an embodiment of the invention;

FIG. 4B is an illustration of exemplary instructions in accordance with an embodiment of the invention;

FIG. 4C is an illustration of exemplary instructions in accordance with an embodiment of the invention;

FIG. 4D is an illustration of exemplary instructions in accordance with an embodiment of the invention;

FIG. 4E is an illustration of exemplary instructions in accordance with an embodiment of the invention;

FIG. 4F is an illustration of exemplary instructions in accordance with an embodiment of the invention;

FIG. 4G is an illustration of exemplary instructions in accordance with an embodiment of the invention;

FIG. 5A is a screenshot showing the beginning of the game in accordance with an embodiment of the invention;

FIG. 5B is a screenshot illustrating a black pawn card being drawn in accordance with an embodiment of the invention;

FIG. 5C is a screenshot illustrating a white knight card being drawn in accordance with an embodiment of the invention;

FIG. 5D is a screenshot illustrating an instruction card to return a piece being drawn in accordance with an embodiment of the invention;

FIG. 5E is a screenshot illustrating a black knight piece being returned to the game in accordance with an embodiment of the invention;

FIG. 5F is a screenshot illustrating the game in progress in accordance with an embodiment of the invention;

FIG. 5G is a screenshot illustrating the game in progress in accordance with an embodiment of the invention;

FIG. 5H is a screenshot illustrating the game in progress in accordance with an embodiment of the invention;

FIG. 5I is a screenshot illustrating the game in progress in accordance with an embodiment of the invention;

FIG. 5J is a screenshot illustrating the game in progress in accordance with an embodiment of the invention;

FIG. 5K is a screenshot illustrating an instruction being shown on the screen in accordance with an embodiment of the invention;

FIG. 5L is a screenshot illustrating a hint being shown on the screen in accordance with an embodiment of the invention;

FIG. 5M is a screenshot illustrating an explanation being shown on the screen in accordance with an embodiment of the invention;

FIG. 6A is a board for a word game in accordance with an embodiment of the invention;

FIG. 6B is a board with four zones for a word game in accordance with an embodiment of the invention;

FIG. 7A is a scoring instruction card for a word game in accordance with an embodiment of the invention;

FIG. 7B is a scoring instruction card for a word game in accordance with an embodiment of the invention;

FIG. 7C is a scoring instruction card for a word game in accordance with an embodiment of the invention;

FIG. 7D is a scoring instruction card for a word game in accordance with an embodiment of the invention;

FIG. 7E is a scoring instruction card for a word game in accordance with an embodiment of the invention;

FIG. 8A is a special move instruction card for a word game instructing the player to get all new letters in accordance with an embodiment of the invention;

FIG. 8B is a special move instruction card for a word game instructing the player to lose 25 points in accordance with an embodiment of the invention;

FIG. 8C is a special move instruction card for a word game instructing the player to gain 25 points in accordance with an embodiment of the invention;

FIG. 8D is a special move instruction card for a word game instructing the player to gain 10 points in accordance with an embodiment of the invention;

FIG. 8E is a special move instruction card for a word game instructing the player to lose 10 points in accordance with an embodiment of the invention;

FIG. 8F is a special move instruction card for a word game instructing the player to exchange any letter in his possession with his opponent in accordance with an embodiment of the invention;

FIG. 8G is a special move instruction card for a word game instructing the player to exchange his letters with his opponent's vowels in accordance with an embodiment of the invention;

FIG. 8H is a special move instruction card for a word game instructing the player to skip his turn in accordance with an embodiment of the invention;

FIG. 8I is a special move instruction card for a word game instructing the player to select any row to start a word in accordance with an embodiment of the invention;

FIG. 8J is a special move instruction card for a word game instructing the player to pick an opponent's consonant in accordance with an embodiment of the invention;

FIG. 8K is a special move instruction card for a word game allowing the player to use an extra space off the board in accordance with an embodiment of the invention;

FIG. 8L is a special move instruction card for a word game allowing the player to swap any letter on the board with his own letter in accordance with an embodiment of the invention;

FIG. 8M is a special move instruction card for a word game allowing the player to remove an “S” on the board in accordance with an embodiment of the invention;

FIG. 8N is a special move instruction card for a word game instructing the player changes color in accordance with an embodiment of the invention;

FIG. 8O is a special move instruction card for a word game allowing the player to form a word with his opponent's letters in accordance with an embodiment of the invention;

FIG. 8P is a special move instruction card for a word game allowing the player to remove an ending to a word on the board in accordance with an embodiment of the invention;

FIG. 8Q is a special move instruction card for a word game causing the player to lose his claim to a specific square on the board in accordance with an embodiment of the invention; and

FIG. 8R is a special move instruction card for a word game allowing the player to claim a specific square on the board in accordance with an embodiment of the invention.

### DETAILED DESCRIPTION OF THE PREFERRED EMBODIMENTS

The invention generally is directed to a game system, game modifier and system and method for playing or teaching a game. Generally, a game system includes a plurality of instruction cards, physical or virtual, or other mechanism for providing an instruction to a player which dictates what move the player makes (collectively referred to herein as “cards”). The instruction may be provided using one or more images, text or a combination thereof. Embodiments of instruction cards include dice or other item having multiple faces, each face having an instruction drawn thereon (referred to generally as “dice”), wherein a player may roll the dice and play the move which appears on the top face of the dice. For example, one dice may be the piece cards, having the King, Queen, Rook, Bishop, Knight, Pawn, respectfully, on six sides of the dice, and a second dice may be the special move cards (“joust cards”), having one special move provided on each face. Alternatively, the piece cards and special move cards may be mixed between two or more dice, or all the instruction cards may be provided on a single dice. In accordance with an embodiment, upon rolling a piece card, a separate dice may be rolled to determine the color of the piece to move.

Thus, the system may permit the players to play without requiring the players to know the rules and strategy of a game, which may be complicated and require extensive training and experience to master. By being told what move to make, the player may focus on how to move each piece, without being distracted with trying to learn strategy of the game, especially when learning a brand new game. Furthermore, dictating what moves the players may make may level the playing field between players of varying levels of skill. Another feature that the invention may provide, which may level the playing field, is the Double Cross card which requires two players to switch sides. Thus, the player who was winning will instantly be losing because of the card drawn.

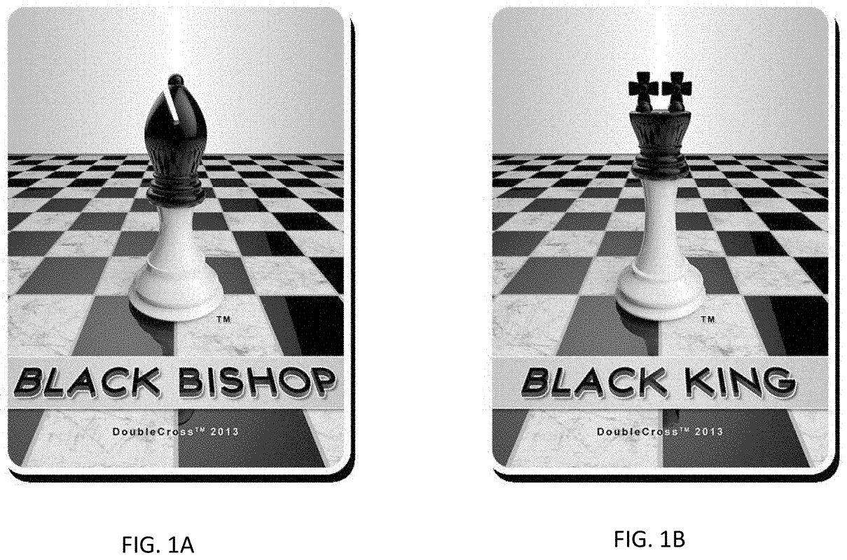

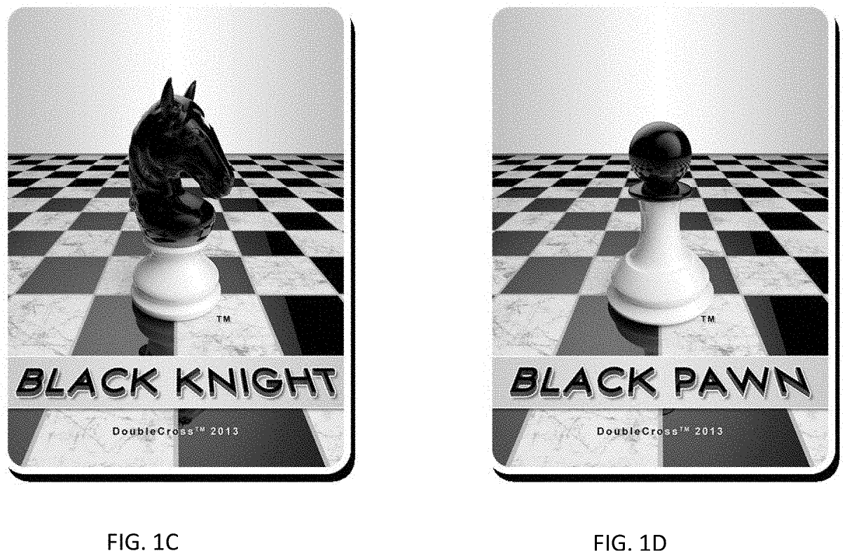

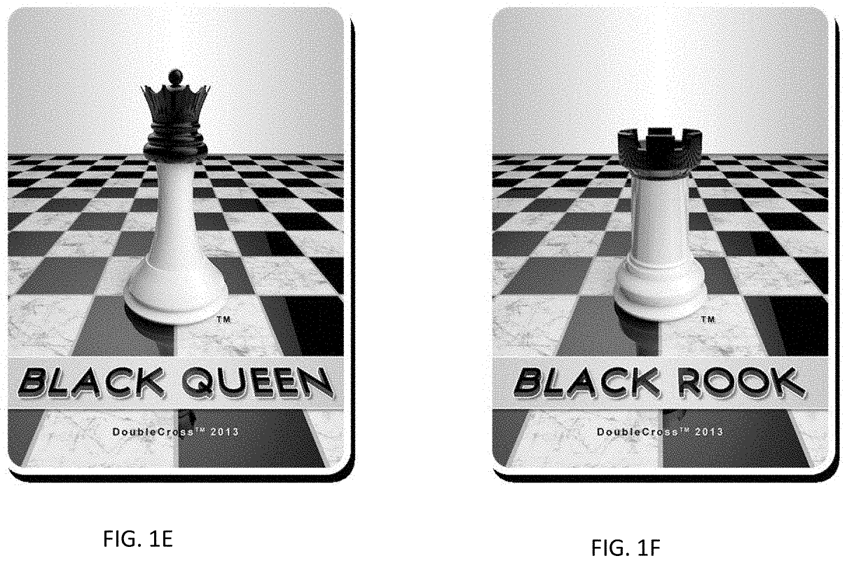

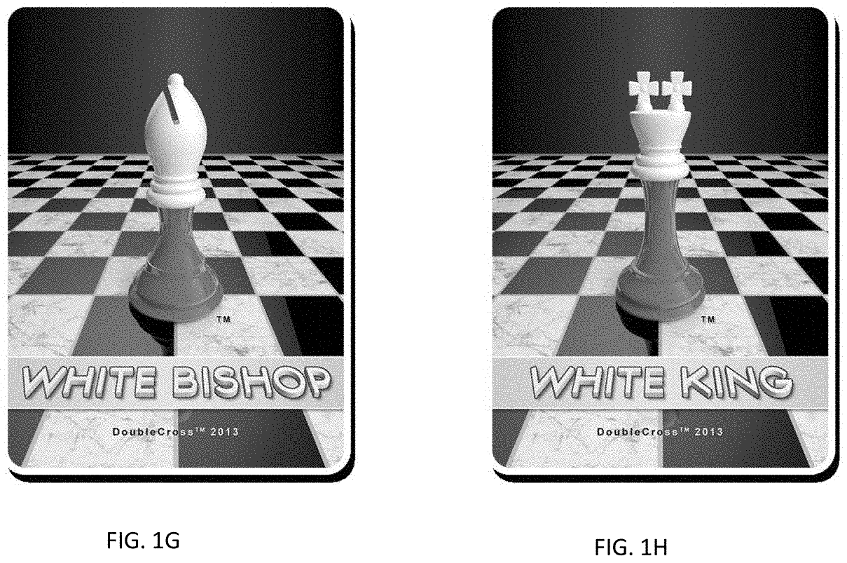

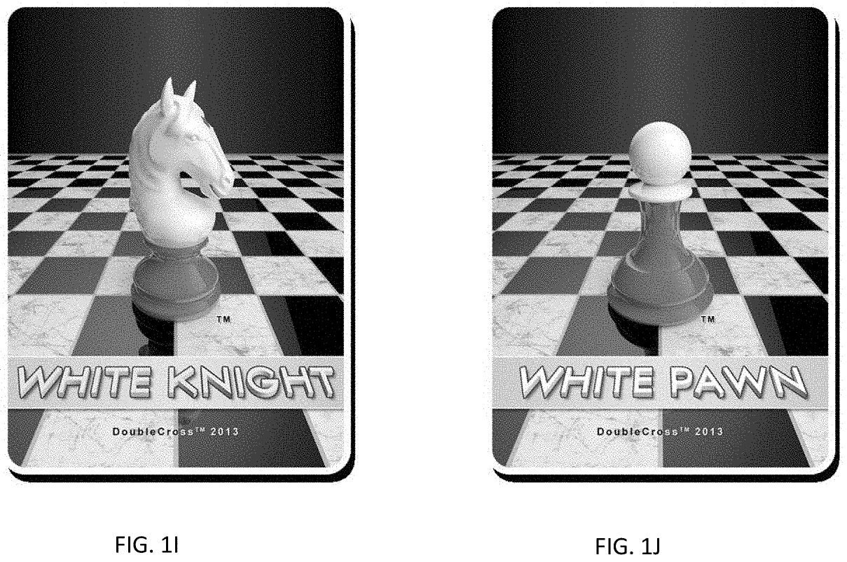

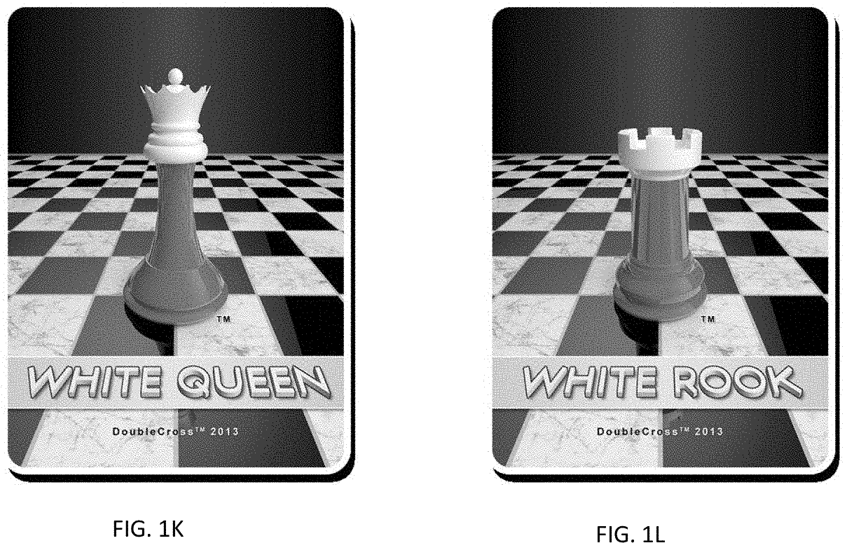

FIGS. 1A-3L illustrate embodiments of the system suitable for use with conventional chess pieces. However, rather than the conventional method of one player controlling all the black pieces and the other player controlling all of the white pieces (or any color combination), wherein each player may move any of his pieces with available moves, the illustrated embodiment limits the pieces that the player may move. The illustrated embodiment of the invention preferably simplifies chess to heighten players' interest and build their confidence without sacrificing the game's cognitive value.

Three exemplary distinctions between traditional chess and an embodiment of the system applied to chess include: (1) unlike in traditional chess, neither player chooses which piece to move, but rather must move the piece (King, Queen, Rook, Bishop, Knight, Pawn) dictated by the card drawn, if a piece card is drawn; (2) the ability to move the opponent's pieces, for example, backwards, into harm's way, out of an threatening position, etc.; and (3) the game may be won upon capturing the opponent's king or based on points scored, rather than by checkmate.

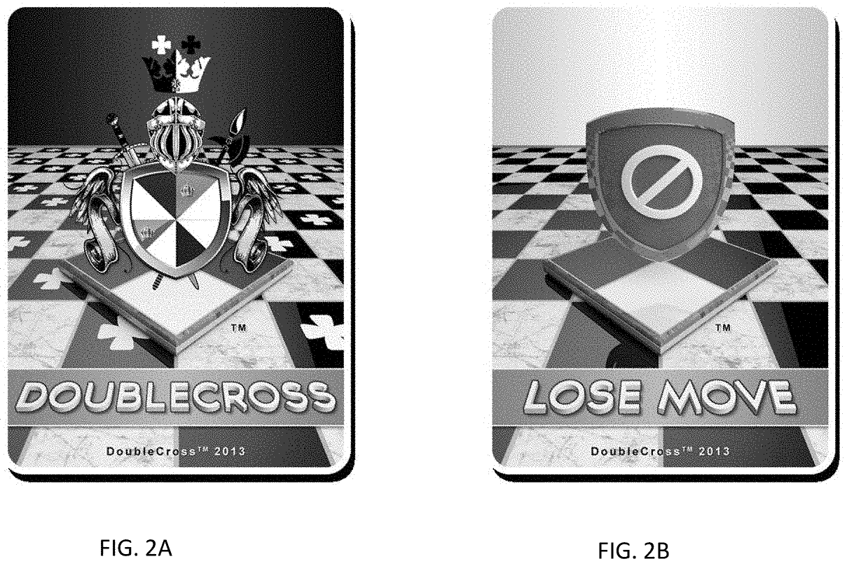

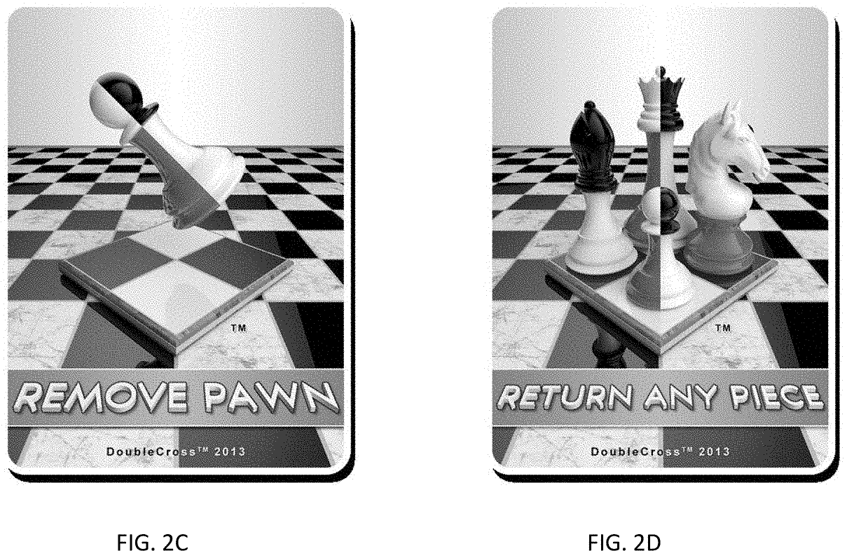

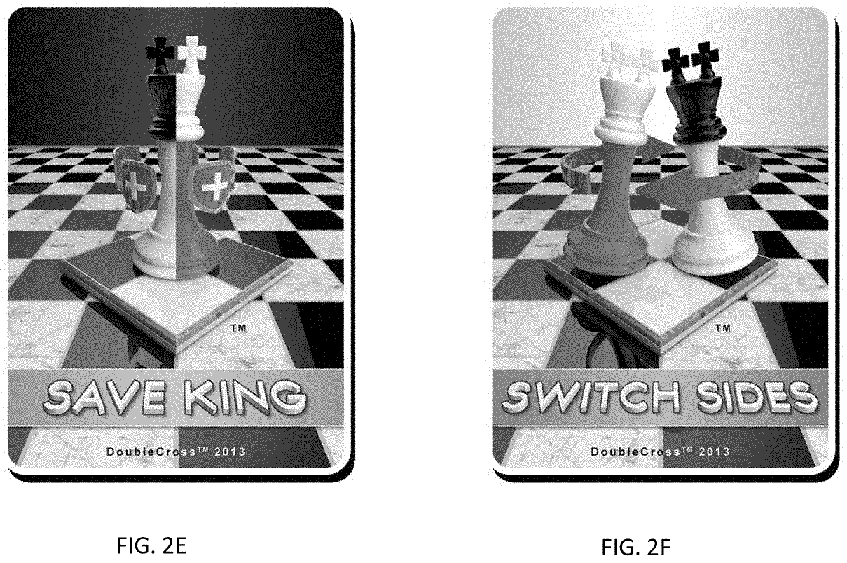

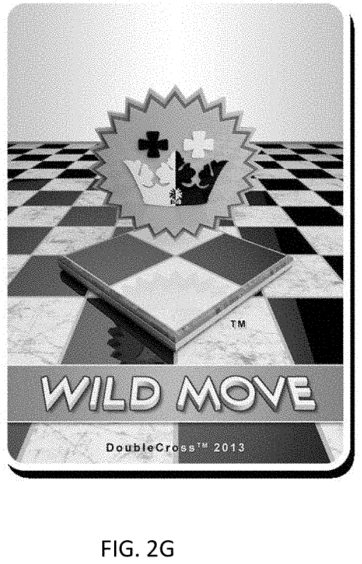

More specifically, rather than simply picking up one of his pieces and moving it, a player draws one of the cards of FIGS. 1A-2G. The card displays either the chess piece that is to be moved, or a special move for the player to make. FIGS. 1A-1L illustrate examples of piece cards that dictate which piece is to be moved. For example, if the player draws a black knight card, he must move a black knight on the chessboard. If he draws a white rook card, he must move a white rook. Whether or not the player's own pieces are black or white is irrelevant. In this embodiment, he is required to move the piece specified on the card. Therefore, the strategy behind which piece to move and where to move it differs from traditional chess. Furthermore, unlike traditional chess in which a player can only advance his own position, the system further permits a player to set back the opponent by moving the opponent's piece.

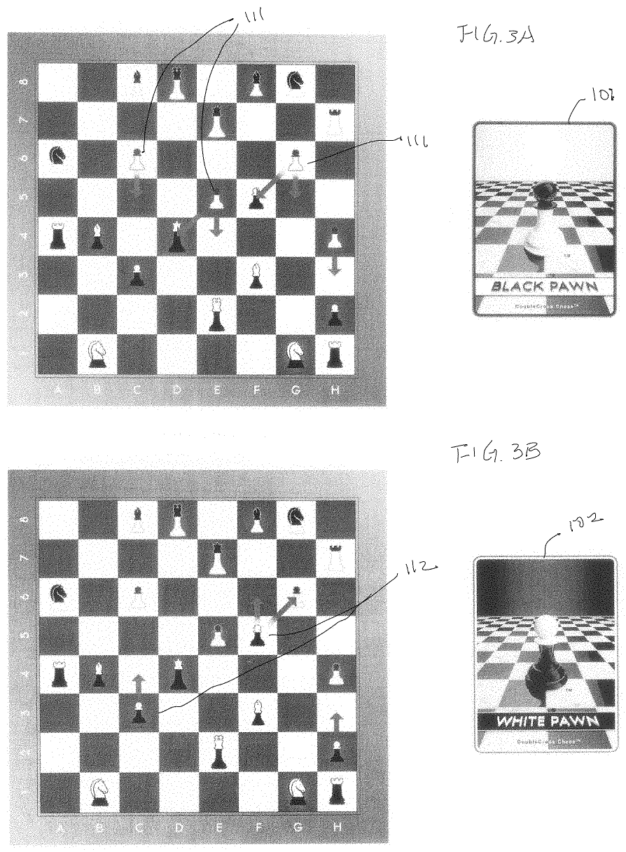

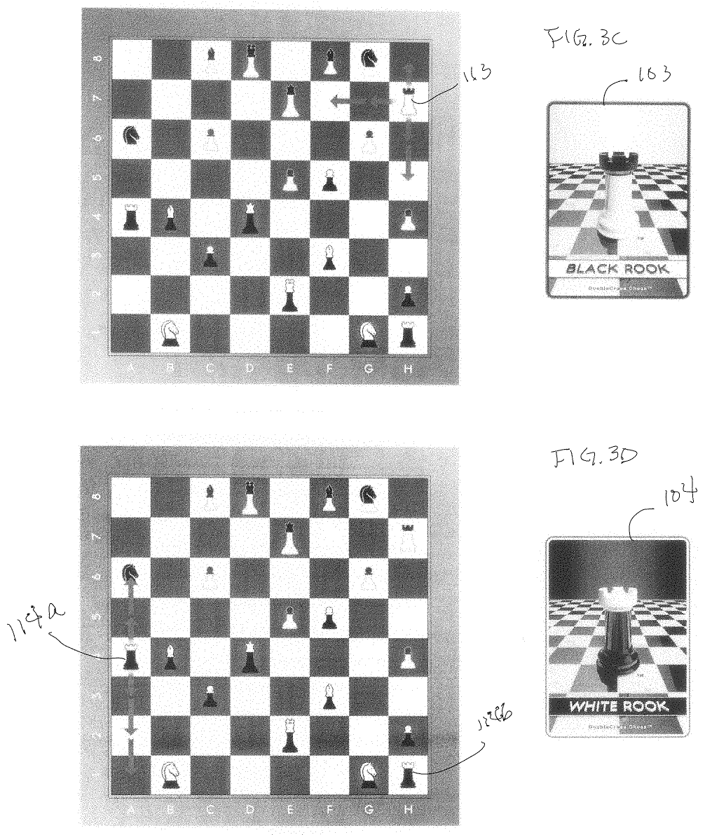

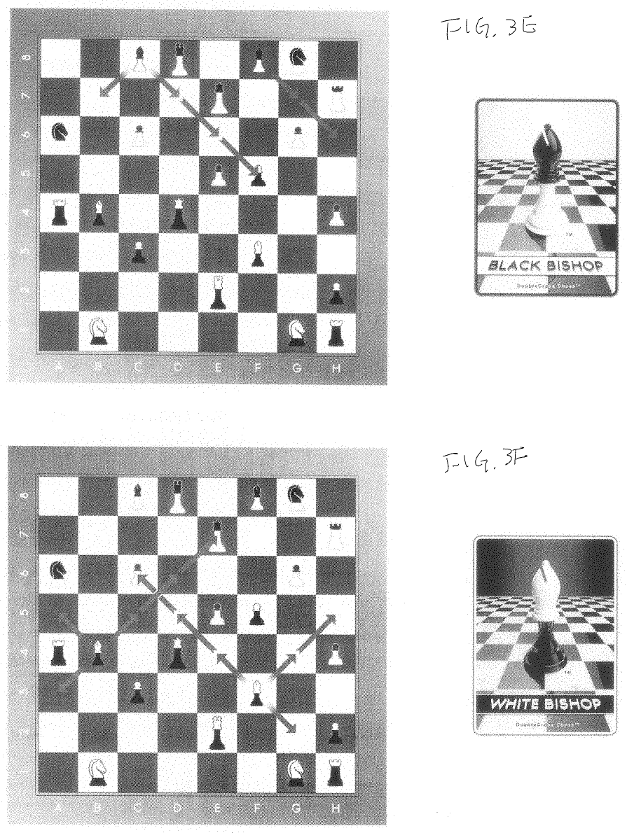

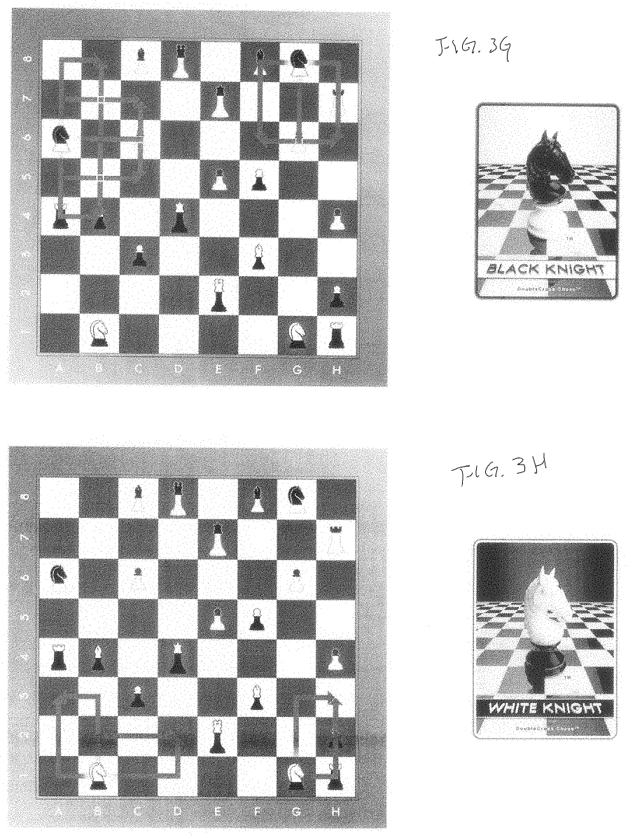

FIGS. 3A-3L illustrate examples of moves a player may make upon drawing certain piece cards. For example, as per FIG. 3A, if the player draws a black pawn card 101, the player must move one of the black pawns 111 on the board. However, if he draws a white pawn card 102, he must move one of the white pawns 112. Likewise, if the player draws a black rook 103 as per FIG. 3C, he must move a black rook 113. In the example shown, there is only one black rook 113, and thus the player must move black rook 113. FIG. 3D shows an example in which the player draws a white rook card 104. Whereas there are two white rooks 114a, 114b on the board, the player must move the first white rook 114a, because the second white rook 114b does not have any legal chess moves available. FIGS. 3E-3L illustrate other examples of moves available to the user according to the piece card drawn.

In the embodiment described, the movement of an opponent's piece must be made as if the player were the opponent. For example, since a pawn must move forward and cannot move backward, the player may not move a black pawn in the same direction as the white pawns (backwards for the black pawn), just because the player's pieces are white. Additionally, an opponent's piece may not be used to capture another piece of the opponent.

Preferably, the game includes cards that provide special moves or options, other than specifying a chess piece to move. Examples of such special moves cards are illustrated in FIGS. 2A-2G. As shown, the special moves or options may include: Lose a Move, wherein the player loses a turn and the opponent draws a card; Remove a Pawn, wherein the player removes any pawn, even his own, from the chess board; Return any Piece, wherein the player returns any removed piece onto the board; Save King, wherein upon the player's king being captured, the capturing move is voided and the capturing piece and the king remain in their positions prior to the capturing move; Switch Sides, wherein the players switch sides, so that the player with the white pieces take on the black pieces, and vice versa; Undo Move, wherein the opponent's last move is undone, including any special moves; and Wild Move, wherein the player may move any piece. The names of the cards may vary without deviating from the scope of the invention. For example, in an embodiment of the invention, Double Cross may require players to switch sides.

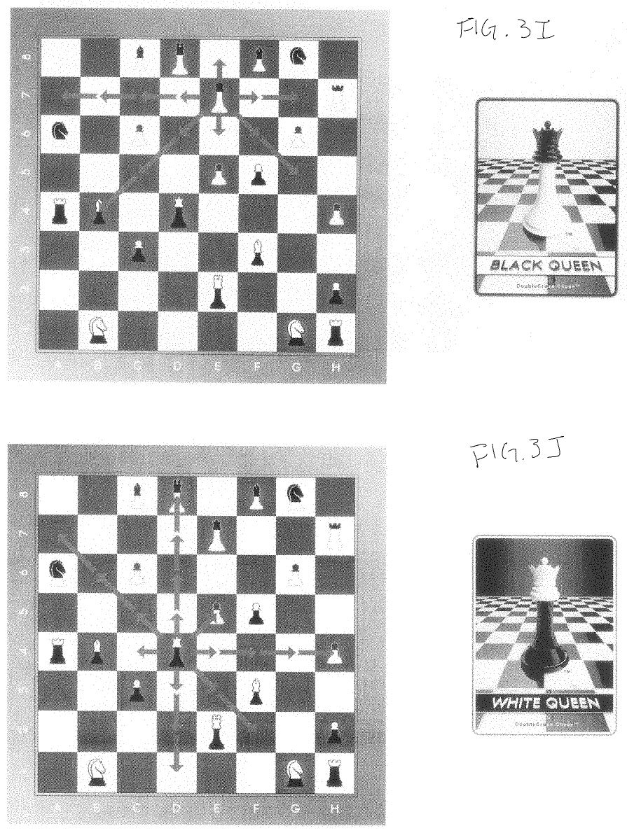

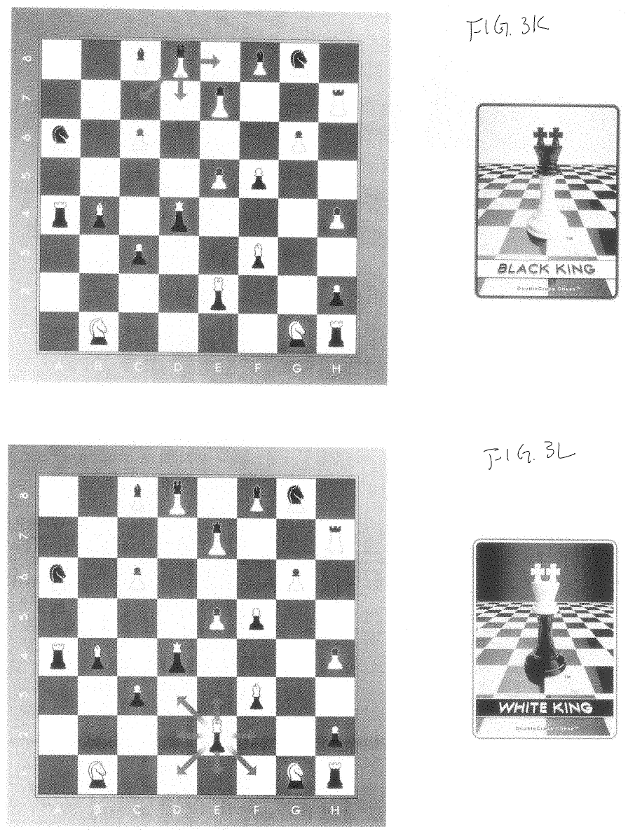

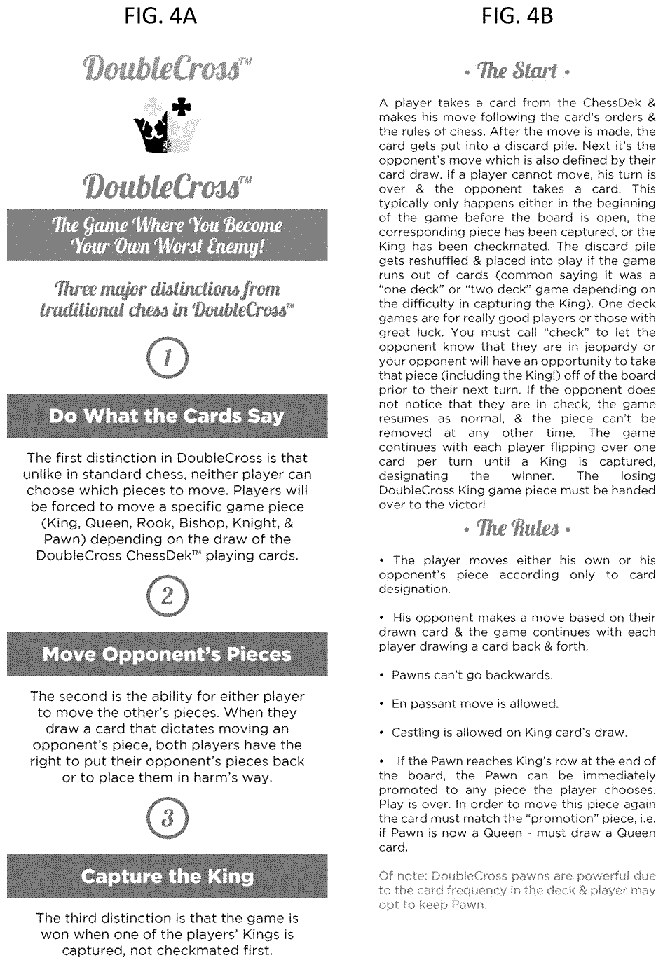

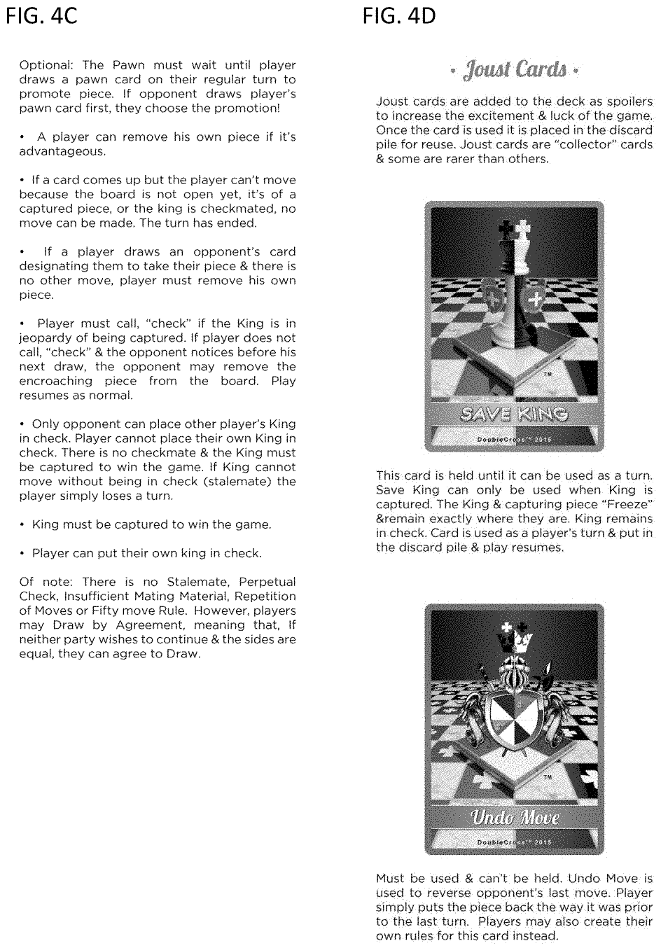

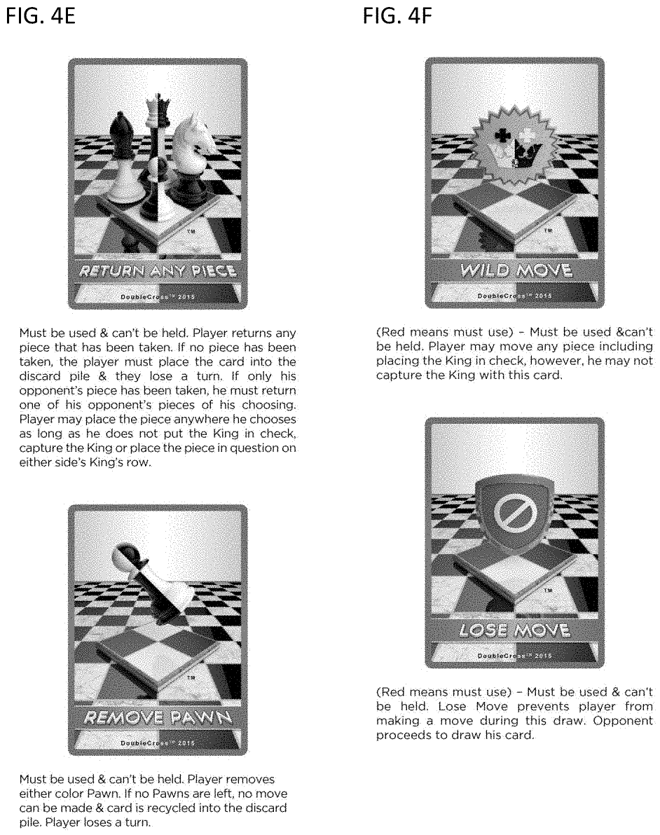

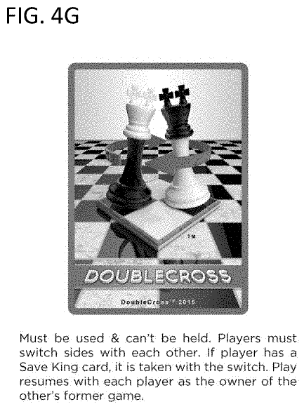

The special moves and options may have limitations and rules associated therewith. For example, certain special moves or options may be saved for later use, whereas others must be used immediately. Reference is made to the exemplary instructions illustrated in FIGS. 4A-4E, under which all the above-mentioned special moves or options must be used immediately except for the “Save King” move, which may be saved until the king is actually captured. While performing a “Wild Move,” the player may not capture the king. Furthermore, when the players switch sides, the “Save King” move stays with the pieces and is given to the other player. When returning a piece, if the player did not have any of his pieces captured, but the opponent did, he must return one of the opponent's pieces. Additionally, when returning a piece, the player may place the returned piece anywhere on the board other than on either side's King's row, including placing the king in check. For the “undo move,” the embodiment provides the players to undo the most recent move by the opponent prior to the player drawing the card, whether that most recent move was moving a piece, promoting a pawn, switching sides, removing a piece, etc.

Generally, in accordance with the embodiment illustrated in FIGS. 4A-4G, the game begins with the pieces placed on the chess board, preferably consistent with traditional chess. The first player draws a card and makes his move accordingly. Then, the second player draws a card and makes his move accordingly. The two players alternate drawing cards and making moves until one player captures the other player's king. If the card drawn is a card specifying a specific game piece, a piece card, the player must move the piece identified on the card in accordance with traditional rules of chess. For example, if he draws a white knight card, he must move one of the white knights according to the moves permitted of a knight in chess. If there are no white knights on the board, or if the white knight(s) have no available move, then the player's turn ends without making a move, and the opponent draws his next card. Once all of the cards have been drawn, the used cards may be shuffled and reused as necessary until the game ends. Alternatively, the players may agree to use two or more decks of cards, rather than reusing the cards. Using multiple decks of cards changes the probability of drawing certain cards, which may change the experience as well. In accordance with the embodiment illustrated, the game does not end until a king is captured by the opponent.

Various rules may be set as preferred. For example, as shown in FIGS. 4A-4E, castling may be permitted on drawing a king card. When a pawn reaches the king's row, the player may use his next move to promote the pawn into another piece, preferably any piece other than a king, such as a queen, bishop, knight or rook. Once the pawn has been promoted, it takes on the identity of the piece to which it was promoted, and thus the rules of that new identity apply. For example, if a white pawn is promoted to white queen, the piece may only be moved by drawing a white queen card. Alternatively, as provided in FIG. 4C, a player may be required to draw the white pawn card again to promote the white pawn. If the opponent draws the white pawn card first, he may choose to which piece the white pawn is to be promoted or move the white pawn off of king's row, thus losing the option for promotion. FIGS. 4D-4G show special move cards referred to therein as “Joust Cards.”

Additional possible rules include prohibiting a player from placing his own king in check or capturing his own king. If a player draws a card dictating a move that would place his own king in check or capture his own king, he loses the turn and does not make a move.

Whereas FIGS. 4A-4E illustrate a set of instructions according to certain embodiments of the invention, it is to be understood that variations in the rules are contemplated without deviating from the scope of the invention. For example, the rules may be such that when a player draws a “Remove Pawn” card, he may remove either player's pawn or only his opponent's pawn, and not his own. Other examples of a rule not illustrated is removing the king cards entirely, or permitting the king pieces to be moved in lieu of drawing a card.

Alternatively, the players may play with only piece cards, and not special move cards, or the number of special cards or piece cards may be varied as preferred. For example the number of king cards may be increased or decreased according to the desired level of difficulty. By way of non-limiting example, a deck may include 8 king cards, whereas another deck may include six king cards to render the game a little more difficult. A deck with four king cards may be more difficult than the previously mentioned embodiments. The decks of cards may have these variations of cards or the players may adjust the number of certain cards before starting a game, as desired. Multiple decks of cards may be used, which may increase the difficulty of the game, by decreasing the impact each card may have on the game.

Another embodiment of the game includes each player moving only his own pieces, and not the opponent's. For example, the cards may designate the piece to be moved, without specifying color. Alternatively, the players may use cards that specify color, but agree to ignore the color, and consider only the type of piece designated. Additionally, the players may be permitted to move his king or pawn at any time in lieu of drawing a card.

Moreover, whereas the examples above are directed to losing a turn if the move designated on the drawn card is not possible, another embodiment may permit the player to draw another card if the designated move cannot be made. For example, if the white queen was captured, but a player draws the white queen card, the player may draw another card, rather than losing his turn. A game may begin with each player being dealt one or two (2) cards, or more, as a matter of preference, which they may hold onto and use at any time during the game instead of drawing a card. Alternatively, each player may be given the option of moving his king or pawn instead of drawing a card for his first move. The players may be required to say “check” upon placing the opponent's king in jeopardy. Failure to do so may grant the opponent the right to remove the jeopardizing piece in lieu of his next move. In accordance with another embodiment, a king piece may check and capture the opponent's king.

Examples of other rules include the losing player giving up the captured king piece to the winning player. Therefore, players may collect king pieces won from other people, and keep a collection of king pieces won from others. Certain players may have a king piece that looks different from traditional king pieces, thus making their king piece more desirable. Certain king pieces may carry different status symbols, representing the level of skill of the player. In computerized embodiments of the system, such as the mobile application described below, players may earn certain skill levels, for example, by beating a certain number of opponents of certain skill levels, after which their king pieces are “upgraded” to represent their skill level. The king pieces are preferably provided independently, so that losing a game will not render a player's set useless.

An exemplary set of cards includes four each of the piece cards shown in FIGS. 1A-1L and the special move cards shown in FIGS. 2A-2G.

Electronic Game

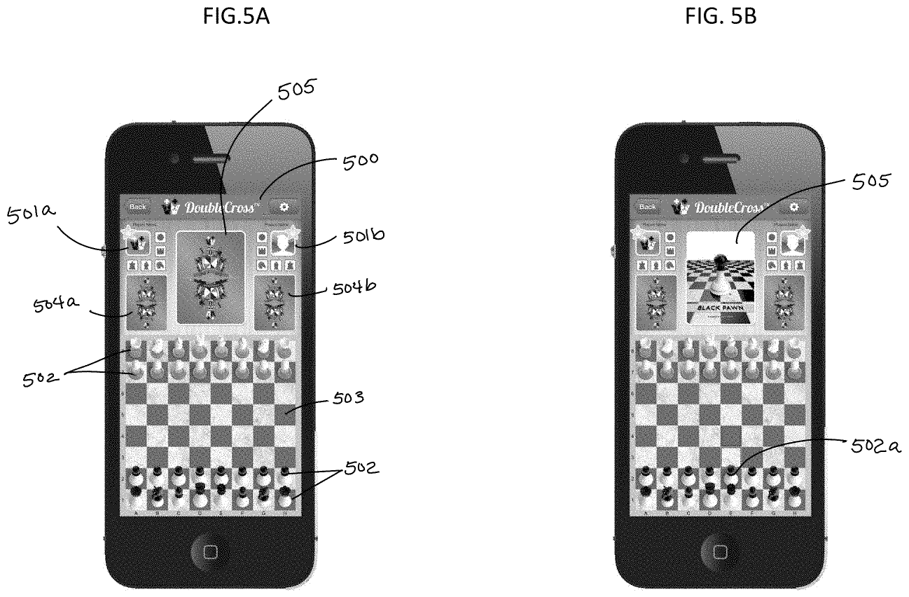

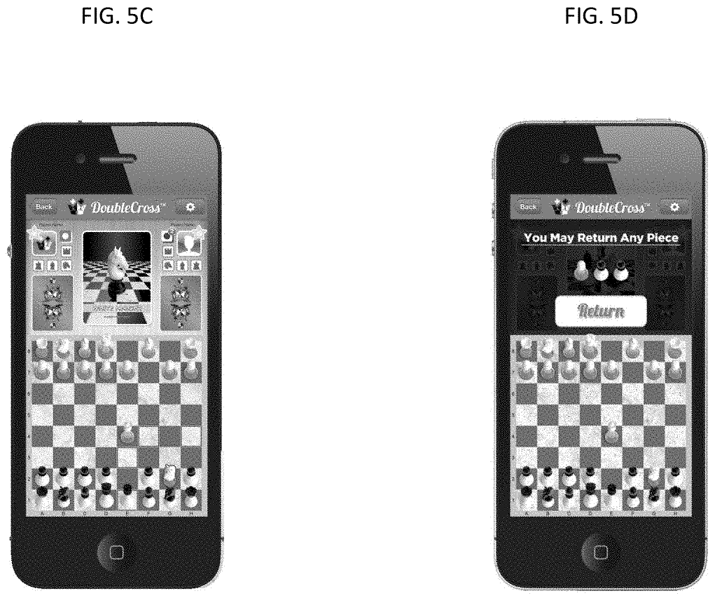

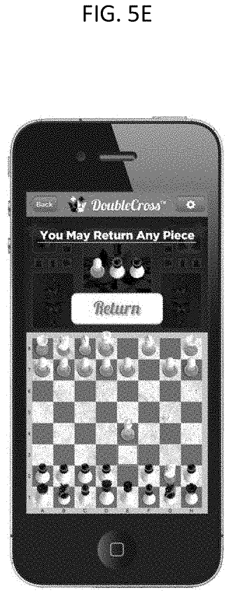

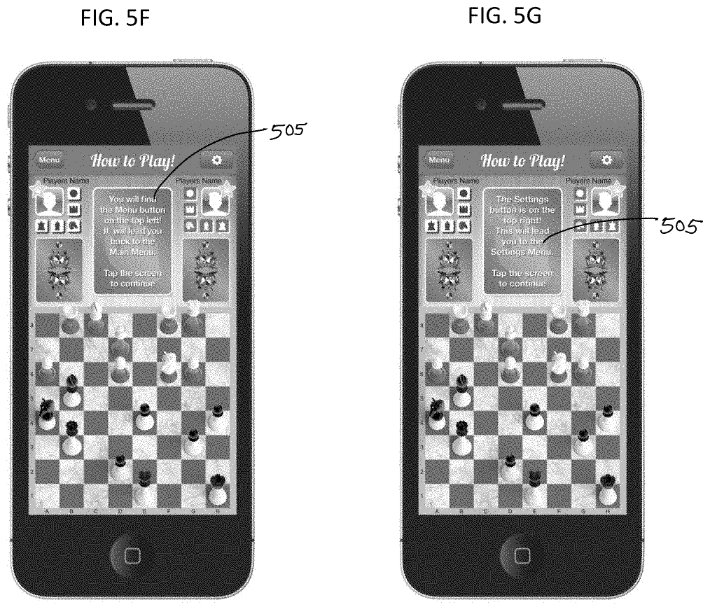

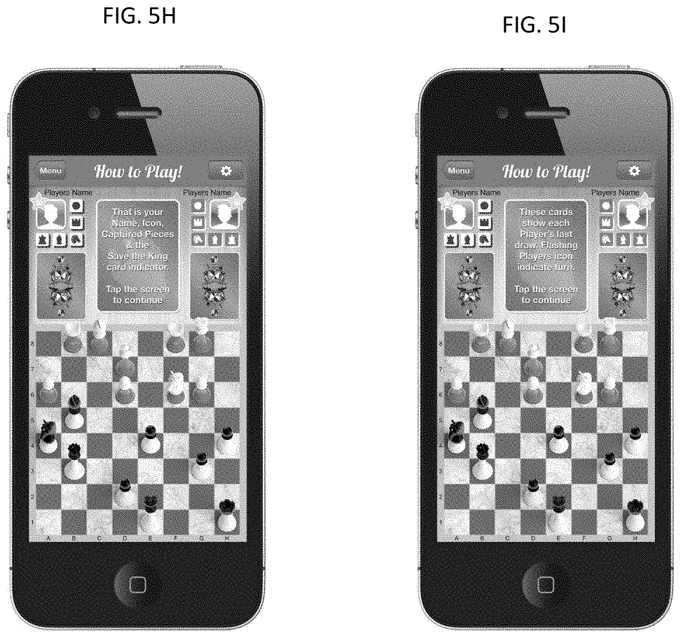

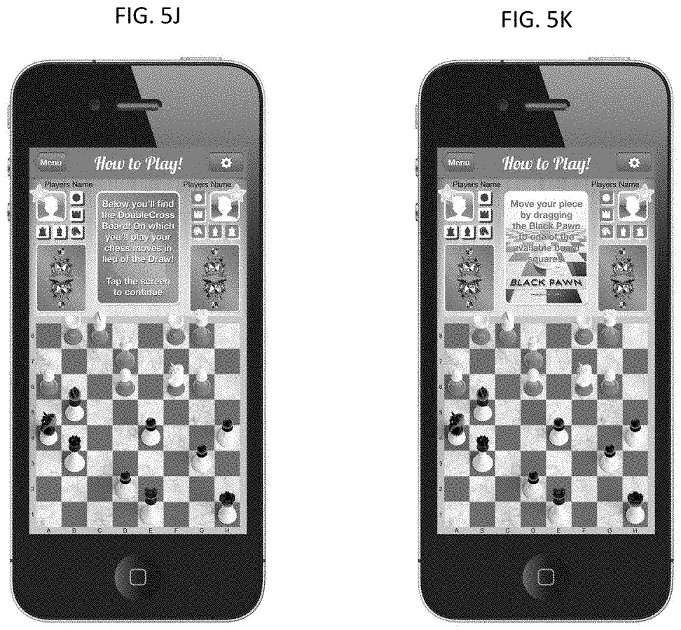

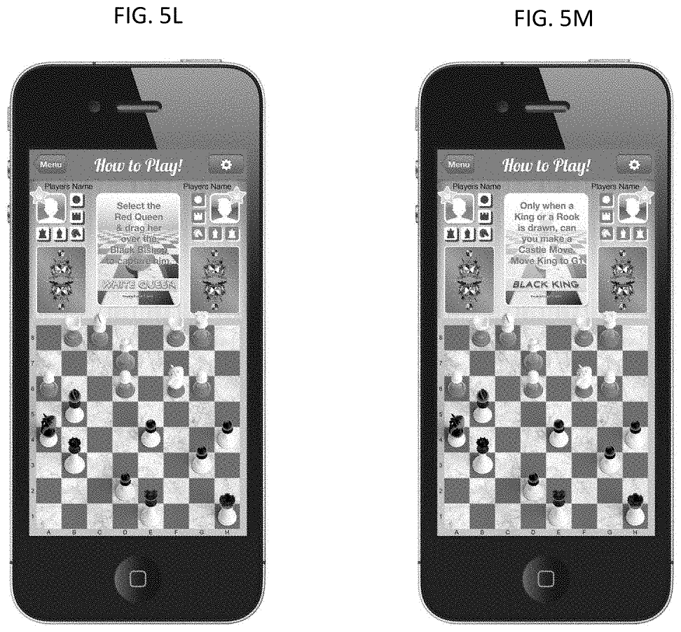

An embodiment of the invention is directed toward a mobile application for playing the game described above. FIGS. 5A-5M illustrate an exemplary embodiment of a mobile application. FIG. 5A demonstrates a screen 500 illustrating the beginning of the game, before either player 501a, 501b makes any moves. As shown, the pieces 502 are arranged on the board 503 in accordance with traditional rules of chess. Each player 501a, 501b have a hidden card 504a, 504b that they may hold for future use. Once a card is drawn, it will appear in area 505 as the drawn card, as shown in FIG. 5B. As shown, a first player 501a draws a black pawn card, and thus he must move one of his black pawns. Once he selects the piece to move, for example, by tapping or clicking on a first black pawn 502a, the possible squares to which first black pawn 502a may be moved are highlighted, along with the first black pawn 502a. Likewise, FIG. 5C illustrates an example when the player draws a white knight card. Same as above, the white knight and the possible squares to which the selected white knight may be moved, are highlighted.

FIGS. 5D-5E provide exemplary screenshots further into the game, after three pieces have been captured, one white and two black pieces. The player draws a “Return a Piece” card, which means he must return one of the captured pieces to the board, and thus a message pops up explaining the move that must be performed. FIG. 5E illustrates the screen after the player selects a black pawn to return, whereafter the possible location(s) where the selected black pawn may be returned. In this example, the piece must be returned to the spot from which it was captured. Alternatively, as described above, the returning piece may be placed anywhere, as a matter of application specific design choice. FIGS. 5F-5J illustrate exemplary screens showing instructions with regard to the mobile application.

Area 505 may also be utilized to display messages, instructions, etc. to the player. When applicable, area 505 is preferably utilized to display the card currently or most recently drawn by the player, save king cards, the player's name, icon, pieces captured, etc. Preferably, the interface includes a notification to indicate the player's turn. For example, the player's icon may flash in area 505, which may help draw the player's attention. When the player draws a card, area 505 may also display appropriate instructions, explanations, hints, possible moves, etc. as shown in FIGS. 5K-5M. More specifically, in FIG. 5K, when the player draws a black pawn card, instructions appear in area 505 stating, “Move your piece by dragging the Black Pawn to one of the available board square.” In FIG. 5L, when a white queen card is drawn, a hint appears in area 505 stating, “Select the White Queen and drag her over the Black Bishop to capture him.” In FIG. 5M, when a black king card is drawn, an explanation and hint appear in area 505 stating, “Only when a King or a Rook is drawn can you make a Castle Move. Move King to G1.”

Preferably, in accordance with the embodiments illustrated, the chess board 503 remains visible regardless of what card is drawn, what instructions, hints, etc. are being displayed, etc. thus permitting the player to view both the board 503 and the hints, instructions, etc. simultaneously. A player may play with another player via a data connection, most preferably by connecting to a server to which the opponent is also connected. Alternatively, two or more players may play locally on a single device, without data connection, by simply passing the mobile device to the next person. A player may also opt to play against the an automated opponent (referred to herein as “computer opponent”), rather than a human opponent, in which case the player may play locally without a data connection, or by connecting to a server, as a matter of application specific design choice.

Word Game

Other embodiments of the invention may be used in conjunction with or to modify other games, more particularly board games. An exemplary embodiment is illustrated in FIGS. 6A-6B, in which the embodiment is utilized with a word game such as Scrabble®. Whereas FIGS. 6A-6B show non-limiting examples of a board 602, 603, it is to be understood that the standard board from Scrabble® or any other suitable board may be utilized without deviating from the scope of the invention.

The embodiment of board 603 shown in FIG. 6B includes four zones. When playing with board 603, each player claims a zone. Preferably, each zone is associated with a color, and each player is assigned the color of the zone. In accordance with an embodiment of the invention, if an opponent places letters in a player's zone, the player receives the points of those letters, rather than the opponent who placed those letters there.

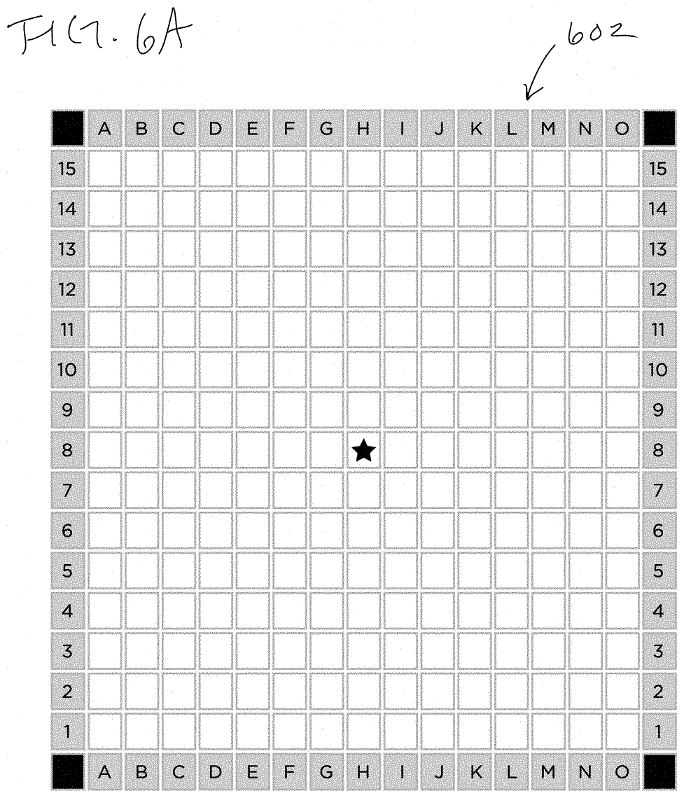

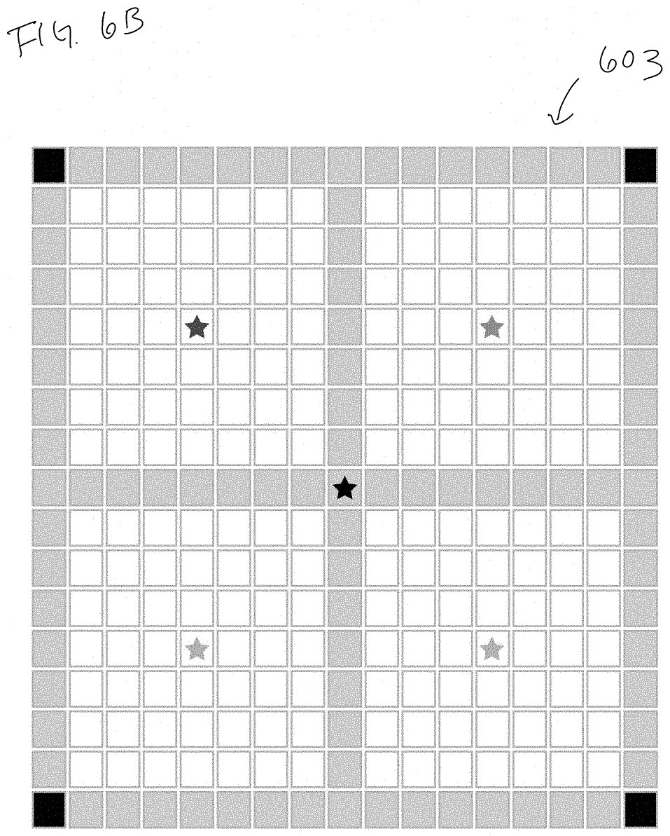

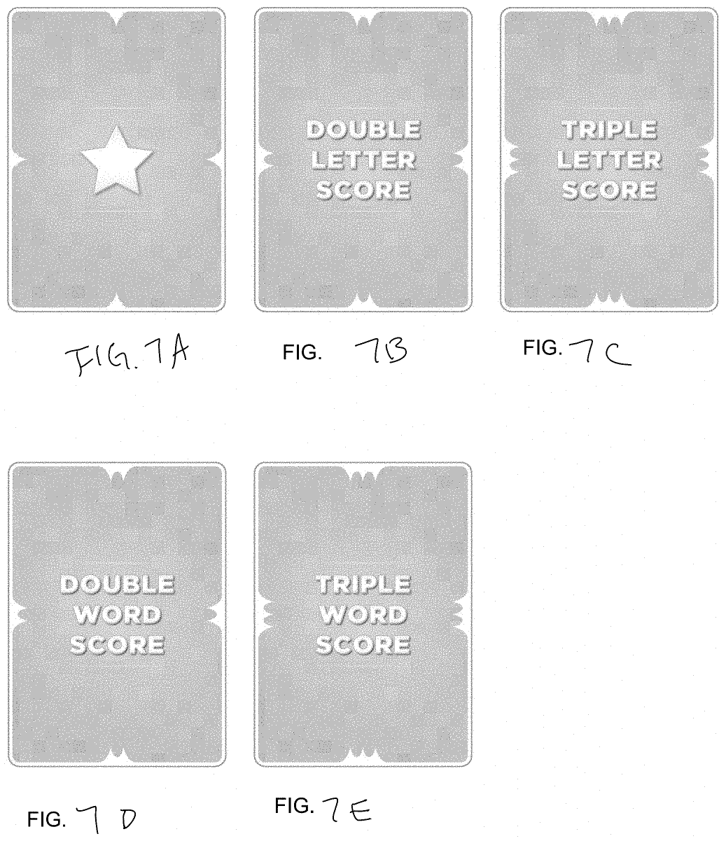

In accordance with the embodiment illustrated, a plurality of cards is provided to instruct the player of the move to make. The cards shown in FIGS. 7A-7E dictate whose letters to use to form a word. Preferably, each player is assigned a color corresponding to the colors of the cards, for example, green, blue, purple and orange. Accordingly, if a player draws a card that is orange, he must form a word using only the letters that the orange player has. Preferably, the color cards also include extra score cards, such as double letter, triple letter, double word and triple word scores, as shown in FIGS. 7B-7E. If the card is colored but doesn't specify any extra points granted, for example as shown in FIG. 7A, the player receives the total points of the word created without any extra points. For double letter or triple letter cards, the letter with the highest score in the word may be doubled or tripled. Preferably, a deck includes the same number of the same cards for each player, preferably differentiated by color. Alternative methods of differentiating the player may be a shape or other image displayed on the card.

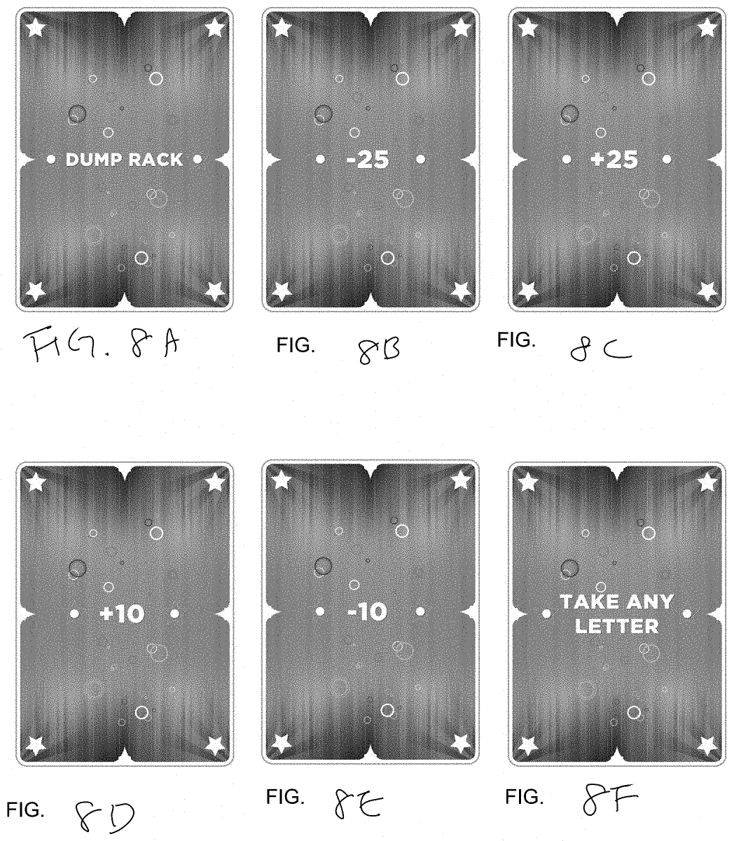

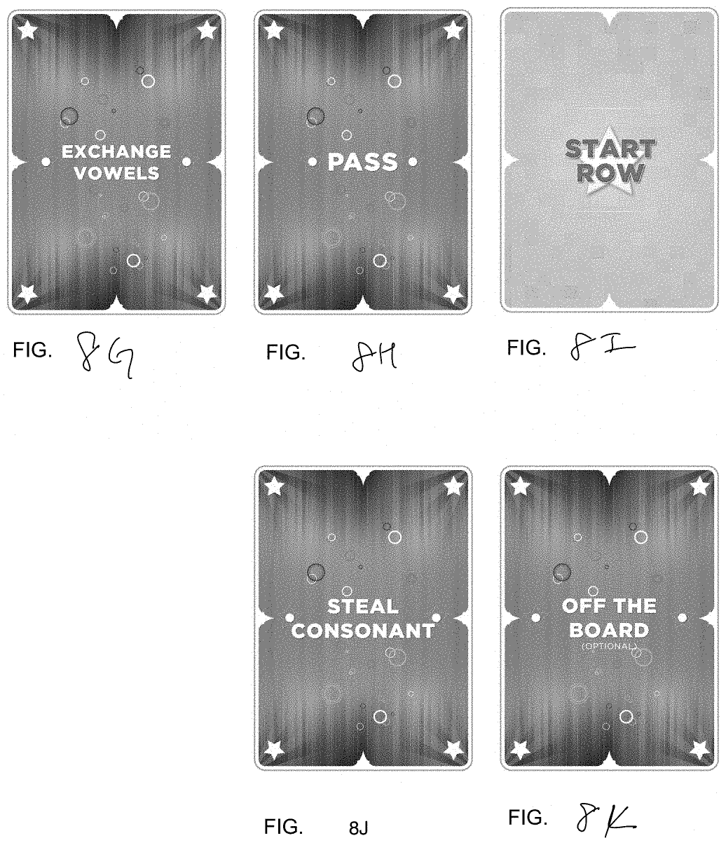

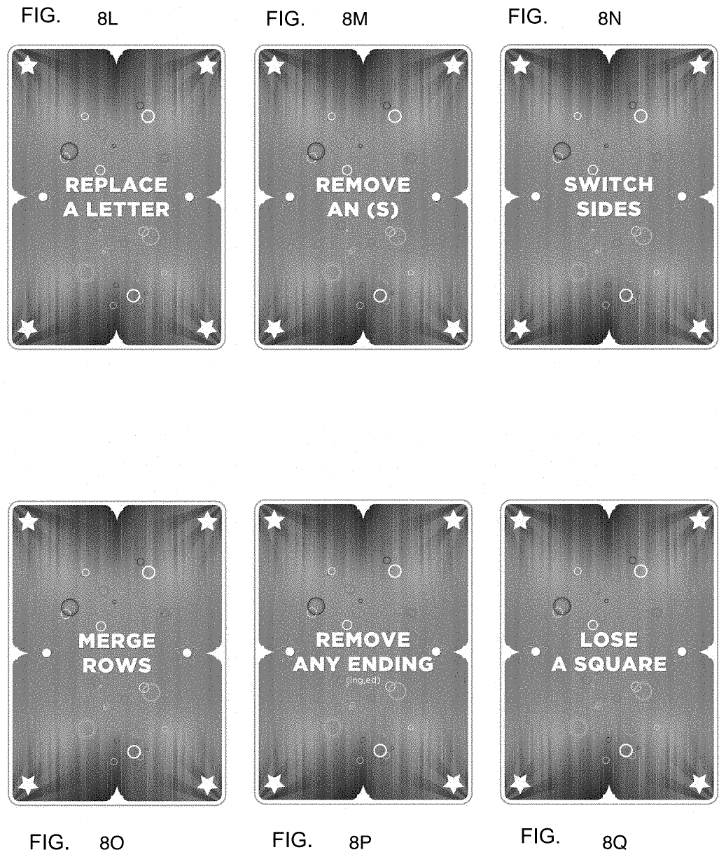

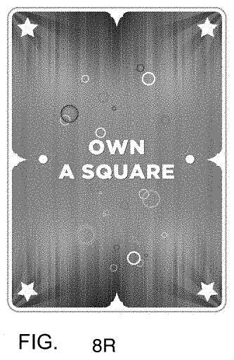

FIGS. 8A-8R show examples of move cards that do not specify whose letters to use. If a player draws a Dump Rack card, as shown in FIG. 8A, the player must change all of his letters and retrieve all new letters, and make a word using those new letters. If a player draws a +25, −25, +10 or −10 card, as shown in FIGS. 8B-8E, the player gains or loses the point value specified on the card, and loses his turn. If a player draws a Take Any Letter card, as shown in FIG. 8F, the player may swap any of his letters with a letter with any of his opponents or the bag or other source of the unused letters. Preferably, the player may hold the Take Any Letter card for use at a later time, in which case he may make a word using the letters he has.

If a player draws an Exchange Vowels card, as shown in FIG. 8G, the player may swap out his letters for his opponents' vowels. All of the opponents disclose their vowels, and the player may exchange as many of his tiles for any of the other players' vowels. In certain embodiments, he may be required to choose one opponent with whom to make the exchange, whereas other embodiments may permit the player to make the exchange with more than one opponent. Preferably, the player may hold this card and use at a later time, in which case he may make a word using the letters he has.

If a player draws a Pass card, as shown in FIG. 8H, the player loses his turn, and may lose points as well as a penalty. If a player draws a Start Row card, as shown in FIG. 8I, the player may choose any square to play a word, even if his word does not touch a previously played word. If a player draws a Steal Consonant card, as shown in FIG. 8J, all the players disclose their highest-point consonant, and the player chooses one and takes it. In accordance with an alternate embodiment, the player swaps one of his tiles for that consonant.

If a player draws an Off the Board card, as shown in FIG. 8K, the player may use one bonus space off the board, illustrated as the extra layer of spaces on the outer perimeter of the board, which would traditionally be prohibited. If a player draws a Replace Letter card, as shown in FIG. 8L, the player removes any letter on the board and replaces it with one of his letters. He then receives the points for the entire word. Preferably, the player may hold this card and use at a later time, in which case he may make a word using the letters he has.

If a player draws a Remove an (S) card, as shown in FIG. 8M, the player removes a letter “S” from the board from a freestanding word having an “S” at the end, for example, “APPLES.” However, the letter may not be removed if it supports another word. The removed letter is returned to the bag, and the player receives points for the remaining word. If a player draws a Switch Sides card, as shown in FIG. 8N, the players change colors. Therefore, the letters, points and saved cards collected by each player for their respective color are passed on to the next player who claims that color. For example, the players may rotate their racks, letter tiles and cards, if they have physical items, to the person to their left or right.

If a player draws a Merge Rows card, as shown in FIG. 8O, the player chooses an opponent and makes a word using his own letters as well as any or all of that opponent's letters. If a player draws a Remove Any Ending card, as shown in FIG. 8P, the player removes an ending from a freestanding word, for example, the “S” from “APPLES,” the “ING” from “SINGING” or “ER” from “HARDER.” However, the letters may not be removed if any of them supports another word. The removed letters are returned to the bag, and the player receives points for the remaining word after the ending was removed.

If a player draws an Own a Square card, as shown in FIG. 8R, the player chooses a square, for example, by stating the coordinates, “A10,” after which the player “owns” that space and the tile played on that square. If there is a tile on the square, the player receives the points of that letter. If the square is vacant, the player receives the points of any letter subsequently placed on the square. The player maintains that square unless someone draws a Switch Sides card or he draws a Lose a Square card, as shown in FIG. 8Q, after which he no longer owns the square. If a player draws a Lose a Square card when he does not own a square, he loses his turn.

Additional rules may be provided without deviating from the scope of the invention. If a player cannot make a word, he may lose his turn and lose points. A player may be penalized by losing points for playing a word that was previously used. Extra points may be awarded for using all the letters on the player's rack or for spelling out certain words, such as “freakout.” Preferably, similar to other word games, the game continues until all the letters are played and the players have no more moves. When all the cards are drawn, they are preferably shuffled and reused. For each time a player passes without creating a word, the passing player may lose points. The points of the letters remaining on each player's rack may be deducted from their final score.

The player with the most points at the end may win, or the first player to reach a certain predetermined score may win, or the winner may be decided according to other predetermined criteria. After all the letters are drawn, a player may choose to lose a certain number of points for the option of stopping their play. For example, the player may lose 25 points and remove themselves and their letters from play, so that if an opponent draws a Merge Row card, that opponent may not use the player's letters.

Whereas embodiments are described above using terms such as “bag,” “tile,” “card,” “square,” etc., it is to be understood that alternatives may be utilized without deviating from the scope of the invention. For example, a physical “bag” is not necessary. The letters, whether they are in the form of tiles, cards, or any other physical form, may also be placed in a pile, container, or other suitable means. Alternatively, the letters need not be in physical form but may be presented online, on a mobile device, computer, or other device, wherein the “bag” refers to the pool of unused letters. Moreover, whereas the examples show and refer to “squares,” the shape of the spaces and arrangement thereof and the board may vary without deviating from the scope of the invention. As described above, a player is not limited to his own letters, but may, depending on the instruction card drawn, be permitted or required to use one or more opponents' letters. The system as described may level the playing field, thus substantially equalizing each player's probability of winning.

Whereas embodiments of the invention directed to systems for use with chess or word games are described herein as including cards, it is to be understood that cards, either physical or virtual, are not necessary. For example, the moves to be made may be provided in a list or independently on a sheet of paper, on a box, in a mobile application, online, or via any other medium, such as a text appearing in a pop up window or other means on the screen of a mobile device, computer, etc.

Moreover, embodiments of the invention may be used to modify other existing games without deviating from the scope of the invention. For example, a plurality of instructions, cards, etc. dictating a move to be made may be utilized in conjunction with other games, such as, by non-limiting example, Solitaire, Backgammon, Parcheesi, checkers, and Crash Landing (an educational strategy game for children in which players help aliens repair a crashed rocket ship). Furthermore, the game does not need to be a board game, but may be a video game, a game played on a computer, game console, handheld device, television, mobile device, etc. without deviating from the scope of the invention. An independent system, such as physical cards or instructions displayed on a device, may be used in conjunction with the game, or the instructions may be integrated into the game itself. Additionally, embodiments of the system may be new games without being used in conjunction with pre-existing games.

By limiting the moves that a player may make, the embodiments of the game system preferably equalizes player ability and evens out player skill levels. Therefore, a lesser skilled player may compete with a more skilled player without their difference in skill level playing as big a role as playing the game as originally designed. Thus, a player who has excelled at the game may enjoy playing the game with someone who is not at the same skill level, and also allows the less skilled player to have an increased chance of winning. In other words, by taking away a player's ability to plot by narrowing his or her move to one specific turn and removing the ability to consider several moves ahead, and by giving the player the ability to move his or her opponent's piece back or in harm's way, the playing field may be leveled and the chances of each player winning equalized. The game includes chance in a game of skill.

System and Method for Teaching

A system and method in accordance with an embodiment of the invention preferably provide an entertaining manner of teaching complex strategy games without disrupting the integrity of the rules of the traditional game or creating a new variation. This may be preferable as strategy games usually must keep the same strategy or risk losing the same audience the game was intended for.

For example, when implementing an embodiment of the system with chess, because a player is instructed what move to make according to the card drawn, a beginner is limited in his options, thus potentially reducing the stress of deciding what move to make. However, because the fundamental rules of chess apply, including how the pieces are permitted to move, the player may become more familiar with chess by focusing on how the pieces are moved. The system thus provides a player an alternate way to learn and memorize the basic moves the player can make, without needing to understand all the move strategy. Furthermore, requiring a player to move an opponent's piece and a switching element, in which the players switch sides, positions or pieces, requires the players to play both offense and defense at the same time. The switching element also forces the player to try to win using the opponent's strategy leading up to the switch, rather than continuing his own previous strategy. The cards guide the student through more diverse game scenarios than the traditional methods, expanding the student's thinking from the basic information and description of the game usually provided to a more meaningful play.

Other alterations may be made without deviating from the scope of the invention. Accordingly, the system and method, the use, steps, order of steps, etc. may be varied as a matter of application specific design choice without deviating from the scope of the invention. It is the intention, therefore, to be limited only as indicated by the scope of the claims appended hereto. For example, if a player draws a card with an instruction that cannot be performed, the player may either lose a turn or be permitted to draw another card until he draws one with a move that he can make, according to application specific design choice. Furthermore, different moves, pieces captured, etc. may be awarded a point value. For example, whereas chess is typically won by capturing the opponent's king, the player with the most points may win even if his king was captured, in accordance with an embodiment of the invention. The players may be given a limited amount of time to make a move, after which he loses his turn. This may be more preferable in a mobile application, wherein upon drawing a card, the timer is initiated.

In accordance with an embodiment of the invention, points earned may be traded in for, by way of non-limiting example, prizes, special pieces, level upgrades, certain stages of the game, certain computer opponents, more powerful pieces, higher-scoring pieces, etc. Certain threshold of points may be required to open more advanced levels, bonus rounds, hidden games, etc.

An alternate embodiment of the invention provides boards that differ from the traditional game's board. For example, a modified chess board may be non-rectangular in shape, such as round, triangular, octagonal, in the shape of a cross, etc. The modified chess board may alternatively be tiered or have three or more “ends” such as three rectangular boards connected by a triangle between the three rectangular boards, five rectangular boards connected by a pentagon, etc. A modified board may facilitate accommodating a different number of players, increase difficulty, provide a novel twist to the game, level the playing field, etc. The shape or other appearance of the pieces may also differ from the traditional pieces of the traditional game without deviating from the scope of the invention.

Certain games in accordance with embodiments of the invention may be a tabletop game, a portable travel-size game, a miniature or gigantic or life-size game, an electronic game playable on a television, computer, tablet, phone, watch, game console, or portable gaming system, etc. The game may be played by accessing a remote server, whether it be to connect to another player or to access the remote database (“cloud”) or locally without accessing a remote server, in which case a data connection is not necessary to play the game.

It is also to be understood that the following claims are intended to cover all of the generic and specific features of the invention herein described and all statements of the scope of the invention which, as a matter of language, might be said to fall there between.

I claim:

1. An article comprising a tangible medium that is not a transitory propagating signal encoding computer-readable instructions that, when applied to a computer system, instruct the computer system to perform operations for playing a game comprising a series of turns by a player and an opponent, the operations comprising:
providing a plurality of player's game pieces, a plurality of opponent's game pieces, and a board;
providing a plurality of virtual cards, wherein the plurality of virtual cards comprise a first set of piece cards each corresponding to one of the plurality of player's game pieces, and a second set of piece cards each corresponding to one of the plurality of opponent's game pieces;
displaying, during the player's turn, one of the plurality of virtual cards randomly selected from a subset of the plurality of virtual cards, the subset including at least one card belonging to the first set of piece cards and at least one card belonging to the second set of piece cards; and
displaying on the board available moves corresponding to the displayed virtual card.

2. The article of claim 1, wherein the plurality of virtual cards further comprises a piece-return card, and when the piece-return card is the displayed virtual card, displaying a subset of the player's game pieces and the opponent's game pieces available for return.

3. The article of claim 1, wherein the player's game pieces and the opponent's game pieces are chess pieces.

4. The article of claim 3, wherein the player's game pieces and the opponent's game pieces each comprise a king piece having a status symbol.

5. The article of claim 1, the operations further comprising:
assigning first player game data to the player and second player game data to the opponent, wherein the first player game data and second player game data include at least one of: piece data associated with the player, board orientation associated with the player, special pieces or cards held by the player, player's order of play, a score, or a handicap.

6. The article of claim 5, wherein the plurality of virtual cards further comprises a switch card, and when the switch card is the displayed virtual card, assigning first player game data to the opponent and assigning second player game data to the player.

7. The article of claim 1, wherein the plurality of virtual cards further comprises a piece-removal card, and when the piece-removal card is the displayed virtual card, displaying a subset of the player's game pieces and the opponent's game pieces available for removal.

8. The article of claim 1, wherein the plurality of virtual cards further comprises a void card, and when the void card is the displayed virtual card, returning the game pieces to a game configuration displayed before the previous turn.

9. The article of claim 1, wherein the subset of the plurality of virtual cards further comprises an equal number of cards belonging to the first set of piece cards and cards belonging to the second set of piece cards.

10. A method, performed by a computer having at least one processor, for playing a game comprising a series of turns by a player and an opponent, the method comprising:
randomly selecting, with the at least one processor, a virtual card to provide for a turn, wherein the virtual card is selected from a set of virtual cards including at least one card corresponding to a player's game piece and at least one card corresponding to an opponent's game piece;
displaying, on a graphical user interface, a board and available moves corresponding to the selected virtual card;
receiving, by the at least one processor, input from the player corresponding to a move selected from the available moves; and
assigning first player game data to the player and second player game data to the opponent, wherein the first player game data and second player game data include at least one of: piece data associated with the player, board orientation associated with the player, special pieces or cards held by the player, player's order of play, a score, or a handicap.

11. The method of claim 10, wherein the set of virtual cards further comprises a switch card, and when the switch card is the selected virtual card, assigning first player game data to the opponent and assigning second player game data to the player.

12. The method of claim 10, wherein the set of virtual cards further comprises a piece-return card, and when the piece-return card is the selected virtual card, displaying a subset of the player's game pieces and the opponent's game pieces available for return.

13. The method of claim 10, wherein the set of virtual cards further comprises a piece-removal card, and when the piece-removal card is the selected virtual card, displaying a subset of the player's game pieces and the opponent's game pieces available for removal.

14. The method of claim 10, wherein the set of virtual cards further comprises a void card, and when the void card is the selected virtual card, returning the game pieces to a game configuration displayed before the previous turn.
